(19) United States
(12) Patent Application Publication
(10) Pub. No.: US 2005/0055203 A1
(43) Pub. Date: Mar. 10, 2005

(54) Multi-rate coding

(75) Inventors: Jari Makinen, Tampere (FI); Janne Vainio, Lempaala (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/732,365

(22) Filed: Dec. 11, 2003

(30) Foreign Application Priority Data
Sep. 9, 2003 (GB) 0321093.7

(51) Int. Cl. G10L 19/02

(52) U.S. Cl. 704/229

(57) ABSTRACT

According to an embodiment of the invention there is provided a method for multi-rate encoding in a communication system. The method comprises the step of providing a codec with sets of tuning parameters for use in selection of codec modes. Each set of tuning parameters provides an average bit rate. A bit rate target is received for encoding a signal by the codec, the bit rate target having any value between the minimum and maximum average bit rate of the codec. An encoding mode is then selected based on the bit rate target and the sets of tuning parameters, and the signal is encoded by means of the selected encoding mode. A multi-rate codec comprising a selector for selecting an encoding mode from a set of encoding modes based on a bit rate target is also provided.

### BACKGROUND OF THE INVENTION

1. Field of the Invention

The present invention relates to multi-rate coding, and in particular, but not exclusively to multi-rate speech coding for communication systems. Other non-limiting examples of the possible coding application include audio coding and video coding.

2. Description of the Related Art

A communication system can be seen as a facility that enables communication sessions between two or more entities such as user equipment and/or other nodes associated with the system. The communication may comprise, for example, communication of voice, data, multimedia and so on. A communication system may provide fixed line and/or wireless communication interfaces. Mobile communications systems refers generally to any telecommunications systems which enable a wireless communication when users are moving within the service area of the system. A typical mobile communications system is a Public Land Mobile Network (PLMN). Another example of wireless communication systems is the Wireless Local Area Network (WLAN). An example of the fixed line system is a public switched telephone network (PSTN).

Practically all modern telephony applications use speech compression to increase the efficiency with which the transmission media are used. The functional entity that performs the compression is called a speech codec. The speech codec encodes the speech into a digital format for transmission. Correspondingly, a speech codec decodes at the receiver output the regenerated bits to provide the recovered speech signal. Most of the modern speech codecs operate by processing the speech signal in short segments called frames. For instance, all GSM (global system for mobile communications) codecs, including the AMR (adaptive multi-rate) codec, use 20 ms frames.

The multi-rate speech codecs may be provided for coding in various communication standards. For example, multi-rate speech codecs may be used for communication on mobile networks such as those based on the WCDMA (wideband code division multiple access), GSM/EDGE (Global System for Mobile communications/Enhanced Data rates for GSM Evolution) and other 3G networks. The multi-rate speech coding may be used for both in circuit switched and packet switched domains. It may also be used in messaging type applications, such as multimedia messaging (MMS). Multi-rate speech coding is advantageous, for example, for transmission over erroneous and capacity limited transmission channels.

The above referenced adaptive multi-rate (AMR) is an example of the multi-rate speech codecs. AMR codecs may be used for narrowband (NB) and wideband (WB) applications. Although the AMR codecs were initially developed for GSM/EDGE and WCDMA radio channels, they can also be used elsewhere, such as for the packet switched networks. For example, the AMR speech codec has been selected for use in the third generation (3G) systems. The AMR codecs may consist of 8 or 9 active speech modes and discontinuous transmission (DTX) functionality.

The multi-rate codecs may use different coding modes. In the prior art multi-rate codecs the mode selection can be based only on transmission quality features such as the network capacity and radio channel conditions. A radio network may utilise the multiple rates for link adaptation to handle the channel fading and error bursts. In a network that relies on fast power control the multi-rate structure may be employed for network capacity control.

A further development has been to use source controlled variable bit rate in an attempt to reduce the average source bit rate without any perceptual degradation in decoded speech quality. An expected advantage of lower average bit rate is lower average transmission power and hence higher capacity in the transmission system. Also storage applications may benefit from the source based bit rate adaptation by using less storage space or storing higher quality speech signal within the existing storage space.

Various source based bit rate adaptation algorithms can be used to determine perceptually the best codec mode for each speech frame. Voice activity detection (VAD) driven discontinuous transmission (DTX) is probably the most commonly used algorithm for optimising the network capacity based on the source signal.

FIG. 3 illustrates a prior art arrangement for a variable speech coding algorithm. Prior-art variable-rate codec algorithms, such as selectable mode vocoder (SMV) algorithm in IS-95 network, select the bit-rate of the encoding parameters before encoding the signal. The selectable mode vocoder (SMV) algorithm then selects for each speech frame one of the four possible coding rates.

The bit rate selection is performed by a rate determination algorithm (RDA). The rate selection is based on the frame characteristics such as voiced speech, unvoiced speech and so on and is controlled by the operation mode of the algorithm. The rate determination algorithm has 4 major operation modes: Mode 0 (premium mode), Mode 1 (standard mode), Mode 2 (economy mode), and Mode 3 (super-economy mode). Each of the different modes gives a different average bit rate for input speech. This provides a fixed trade off between average data rate and speech quality.

The prior art variable rate codec is thus provided with a group of speech codecs with different bit rates. Each mode provides a certain average bit rate, with some tolerance. Each mode has certain usage of each speech codecs such that modes with higher average bit rate get greater portion of usage time of available speech codecs than speech codecs with low bit rates.

The prior art codec implementations do not support source based rate adaptation nor average bit rate control for active i.e. continuous speech. For example, in the AMR-WB and AMR-NB speech codecs, voice activity detection (VAD) is used to lower the bit rate during periods of silence. However, although the bit rate can be changed during active speech based on the transmission channel conditions by link adaptation (LA), the bit rate cannot be changed during active speech based on source speech signal.

The following describes an example of how mode selection can be done in prior art based on speech characteristics. In the prior art the mode selection algorithm exploits the calculated speech parameters from the current and past speech frames for classifying the speech into different kind of classes. Therefore speech mode for each speech frame is chosen according to detected speech class. The speech classes can be e.g. for low energy sequences, transients, unvoiced and voiced sequences. Source adaptation algorithm may exploit spectral content, gains and zero crossing rate of previous speech frames for finding the current speech class. The encoding of the speech is then done based on the detected speech class. During transient sequences, speech quality may degrade very rapidly, if modes with lower bit rates are used.

A prior art source adaptation algorithm may operate for every speech frame. In this example the active mode set provides the required information about available speech codec modes. The exemplifying algorithm uses three modes from the active codec set each having a different bit rate. The mode with highest bit rate may be used for encoding the transient, unvoiced and some voiced sequences. The mode with lowest bit rate may be used for encoding the low energy sequences. Basically all other cases, which are not classified into these two sequences, are encoded with the mode having the middle bit rate. The exemplifying source adaptation algorithm exploits the frequency content variation of speech and estimate about residual error. Residual error is the difference between synthesized speech and input i.e. original speech. Residual error is one variable that can be used for deciding the encoding resolution i.e. choosing the operating speech codec mode, and therefore it can be considered in source adaptation. Fixed codebook gain is used as a residual error estimate and it is scaled based on background noise and speech power level. Frequency content is analysed by calculating the zero crossing rate over every frame and examining the variation of it. Speech and noise levels, fixed codebook gain and active speech mode set are exploited, when calculating the decision thresholds in the algorithm.

In the example above, the average bit rate can be selected only from the pre-determined set of discrete values. Therefore the average bit rate control may not be flexible enough for all application to control the speech quality and capacity trade-offs.

In the prior art multi-rate encoding arrangement the bit rate is controlled by the operator of the network. The control allows the operator to balance between voice capacity and voice quality. The operator may decide to switch to lower fixed bit rates during busy hours to increase the capacity. However, in the prior art solution, operator can only control the bit rate by fixed values (e.g. 4.75, 7.40, . . . , 12.2 kbps). The bit rates available for the operator are the bit rates of the modes in the active mode set.

This may be disadvantageous in certain situations. Speech quality may decrease rapidly when used mode is switched for a lower fixed bit rate. The network may not be controlled and optimised in flexible enough manner. For example, if a network may use three modes 4.75, 7.40 and 12.2 kbps as a subset, it may be difficult to optimise the network load for, say 100 or more users. The only solution left for the operator in this example would be to switch all or most of the users directly from the 12.3 kbps mode to the 4.75 kbps mode. This, however, would cause considerable speech quality degradation.

Furthermore, if the desired number of discreet target bit-rates is high or not known when designing the codec, then it may also become fairly cumbersome and time consuming to create and optimise big parameter tables for every possible target bit-rate. Lets consider an example wherein a system operates at target bit-rates between 4.75 kbit/s and 12.2 kbit/s and where the operator wants to change the bit-rate target with steps of 200 bit/s. In this example it would be necessary to optimise and store about 40 different sets of parameters for different bit-rates. This would require considerable work to apply a codec in the system requiring this number of discreet bit-rates or even more difficult in the system having totally non-discreet bit-rate target.

### SUMMARY OF THE INVENTION

Embodiments of the present invention aim to address one or several of the above problems.

According to an embodiment of the invention there is provided a method for multi-rate encoding in a communication system. The method comprises the step of providing a codec with sets of tuning parameters for use in selection of codec modes. Each set of tuning parameters provides an average bit rate. A bit rate target is received for encoding a signal by the codec, the bit rate target having any value between the minimum and maximum average bit rate of the codec. An encoding mode is then selected based on the bit rate target and the sets of tuning parameters, and the signal is encoded by means of the selected encoding mode.

According to another embodiment of the invention there is provided a multi-rate codec comprising an encoder for encoding signals and a source for provision of sets of tuning parameters. Each set of tuning parameters provides an average bit rate. The codec comprises further an input for a bit rate target, the bit rate target having any value between the minimum and maximum average bit rate of the codec, and a selector for selecting an encoding mode from a set of encoding modes based on the bit rate target and the sets of tuning parameters. The codec is configured to encode signals by means of an encoding mode selected by the selector.

According to yet another embodiment of the invention there is provided a communication system comprising a transmitting node provided with an encoder for encoding signals and a receiving node provided with a decoder for decoding signals from the transmitting node. The system comprises a storage for storing sets of tuning parameters, each set of tuning parameters providing an average bit rate, an input for a bit rate target, the bit rate target having any value between the minimum and maximum average bit rate of the codec, and a selector for selecting an encoding mode from a set of encoding modes based on the bit rate target and the sets of tuning parameters, the codec being configured to encode signals by means of an encoding mode selected by the selector.

In more specific embodiments of the invention the bit rate target may be changed during an active connection.

The mode may be selected based on a set of tuning parameters defined for different bit rate targets. The selection of tuning parameters may be based on estimated average bit rate and a bit rate target. Parameters of a mode selection algorithm may be based on a bit rate target. Selection thresholds may be set based on a bit rate target.

The codec may be operated such that the average bit rate of the codec is settled to the bit rate target. The average bit rate may be produced by changing between at least two different fixed bit rate modes in accordance with at least one set of tuning parameters.

The selection of the mode may be performed by means of a loop formed by an average bit rate estimation function, a bit rate target tuning function, a source of tuning parameters, and a mode selection algorithm.

The step of selecting an encoding mode may comprise the selector changing adaptively between different sets of tuning parameters defined for different bit rate targets.

Further information in addition to the bit rate target may be used in the selection of an encoding mode.

Embodiments of the invention may provide a source adaptive codec enabling more flexible and optimised use of variable bit rates. A continuous and substantially real-time trade-off between voice capacity and voice quality may be provided. Speech quality may be increased by the variable rate coding of the embodiments as a result of more efficient encoding. Power may be saved since encoding may be done with lower bit rates.

### BRIEF DESCRIPTION OF THE DRAWINGS:

For better understanding of the present invention, reference will now be made by way of example to the accompanying drawings in which:

FIG. 1 shows schematically a communication arrangement employing speech codecs;

FIG. 2 shows schematically a speech encoder configured to provide source based bit rate adaptation;

FIG. 3 shows the structure of a prior art bit rate determination algorithm;

FIG. 4 presents the structure of a bit rate determination algorithm in accordance with an embodiment of the present invention; and

FIG. 5 is a flowchart illustrating the operation of one embodiment of the present invention.

### DETAILED DESCRIPTION OF THE PREFERRED EMBODIMENTS:

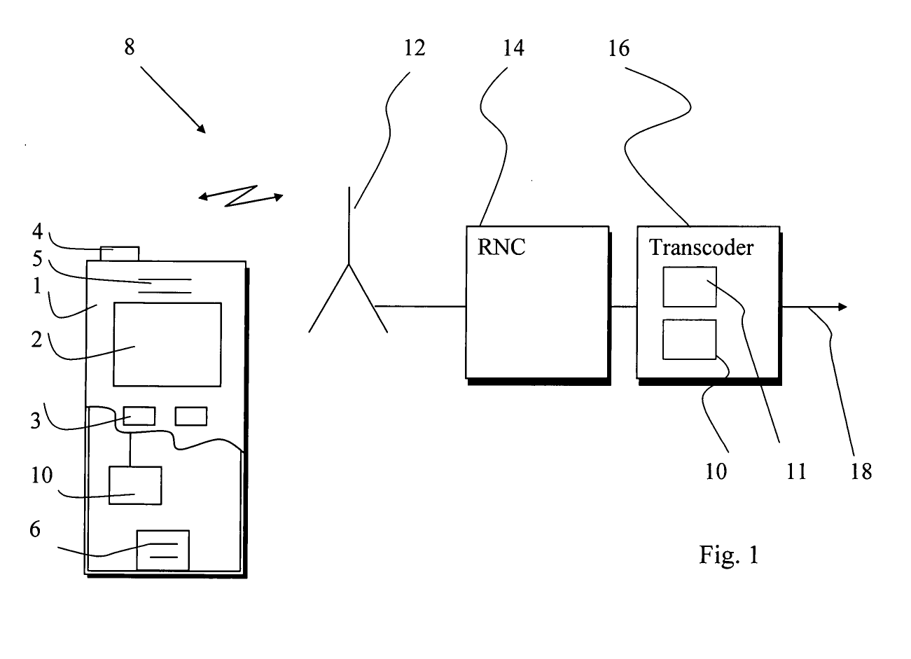

The following describes in more detail possible bit rate adjustment mechanisms for the provision of a source adaptive speech codec. In this regard reference is first made to FIG. 1 which shows a communication system wherein the present invention may be employed. The shown communication system is capable of providing wireless data transportation services for a mobile user equipment 1 by means of a public land mobile network (PLMN) 8.

The user equipment 1 is also shown to comprise a speech codec 10. The operations thereof will be described in more detail below after the brief description of other possible features of the user equipment and possible elements of a communication network.

The skilled person is familiar with the features and operation of a typical mobile user equipment. Thus it is sufficient to note that the user may use the mobile user equipment 1 for performing tasks such as for making and receiving phone calls, for receiving content from the network and for experiencing the content that may be presented to the user by means of the display and/or the speaker and for interactive correspondence with another party. The user equipment 1 may also be provided with means such as data processing means, memory means, an antenna 4 for wirelessly receiving and transmitting signals from and to base stations, a display 2 for displaying images and other visual information for the user of the mobile user equipment, speaker means 5, microphone means 6, control buttons 3 and so on.

It shall be appreciated that the exemplifying user equipment and the various elements of a user equipment are shown only for the reasons of helping to describe a possible context where the invention may be embodied. It shall also be appreciated that the term mobile station is intended to cover any suitable type of wireless user equipment, such as mobile telephones, portable data processing devices or portable web browsers.

The elements of the PLMN network 8 are also discussed briefly to clarify the operation of a typical PLMN. A mobile station or other appropriate user equipment 1 is arranged to communicate via the air interface with a transceiver element 12 of a radio access network of the PLMN. The transceiver element 12 may be provided by means of a base station. The term base station will be used in this document to encompass all entities which may transmit to and/or receive from wireless stations or the like via the air interface. The base station 12 is controlled by a radio network controller (RNC) 14.

The network 8 is also shown to comprise a transcoder entity 16. The transcoder entity 16 comprises two speech codecs 10 and 11. The codec 10 is for encoding speech for downlink transmission to the mobile user equipment 1. The codec 11 is for decoding transmission received via the uplink from the user equipment 1 and encoded by the codec 10 of the user equipment 1. It shall be appreciated that the transcoder entity 16 may be integrated with any suitable network entity, such as with the radio network controller 12. Furthermore, a codec may be use for both encoding and decoding.

The speech codec 10 of the user equipment 1 may comprise an AMR speech codec. The pre-processed signal from the microphone 6 may be encoded using any appropriate encoding, for example the commonly used ACELP (Algebraic code excited linear prediction) technology. If ACELP is used, the encoder output bit stream may include typical ACELP encoder parameters. Non-limiting examples of these parameters include LPC (Linear prediction calculation)parameters quantised in LSP (Line Spectral Pair) or ISP (Immittance Spectral Pair) domain describing the spectral content, LTP (long-term prediction) parameters describing the periodic structure, ACELP excitation parameters describing the residual signal after linear predictors, and signal gain parameters.

The encoded bit stream from the ACELP analysis is then transmitted from the user equipment 1 via the uplink to the decoder 11 of the network. After the core decoding process the synthesised signal is further post processed to generate the actual output 18 from the decoder 11. Mode information may be needed by the decoder, for example because decoding of the LSP, LTP and ACELP excitation quantisation may depend on the used codec mode.

The encoding codec 10 may be adapted to use variable multi-rate scheme. The rate and the mode may be changed between subsequent frames. The codec mode may even be selected independently for each analysis frame, for example with 20 ms intervals. The selection of the appropriate mode may depend on features such as the source signal characteristics, desired average bit rate target and supported mode set.

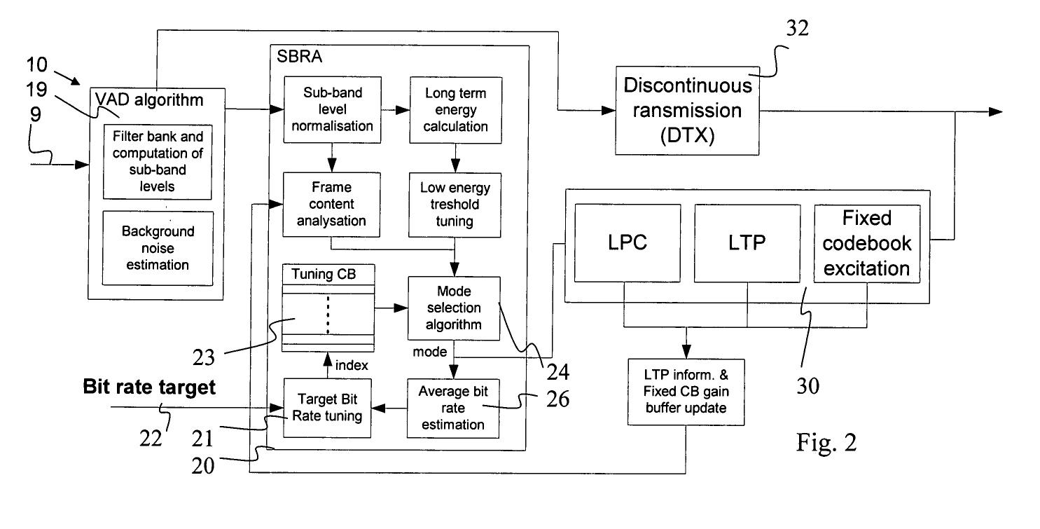

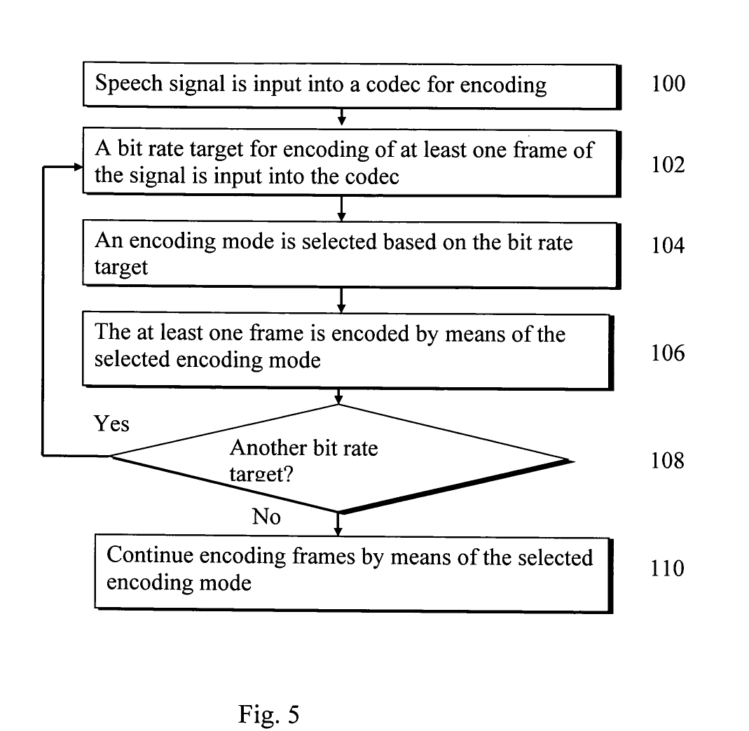

In the following an exemplifying method to control the bit rate of multi-rate speech codec is described in more detail with reference to the codec 10 of FIG. 2, a rate determination algorithm that is schematically shown in FIG. 4 and the flowchart of FIG. 5.

In the described exemplifying embodiment the bit rate of a speech codec can be adjusted based on a bit rate target. The average bit rate used for speech transmission over wireless channel can be tuned continuously based on the available codec modes and radio network load.

FIG. 2 shows as a block diagram possible functional entities of a multi-rate speech codec 10 in accordance with the present invention. The codec is shown to comprise a Voice activity detection (VAD) block 19 for receiving the input speech 9. Input of the speech is also shown at step 100 of FIG. 5. The VAD block 19 is configured to supply speech signal to a discontinuous transmission (DTX) block 32 for processing of the speech signal in accordance with the selected codec mode. The VAD block 19 may also feed speech signal to a source based bit rate adaptation algorithm block 20.

The source based bit rate adaptation algorithm block 20 is for adapting the bit rate of the codec based on a desired bit rate target. In FIG. 5 a bit rate target is input at the codec in step 102. The input bit rate target 22 is used by the block 20 in selection of an appropriate encoding mode for use by the encoding block 30 from a set of possible modes at step 104. At this step tuning parameters are fetched from the source of tuning parameters, for example from a storage provided as an integrated part of the codec or from an external source.

The tuning parameters are arranged into sets of tuning parameters. A set of tuning parameters preferably defines a mode that produces a predefined average bit rate for a source signal with certain source signal characteristics. In the preferred embodiment the average bit rate is produced by changing between different fixed bit rate modes. Because the sets of tuning parameters associate with different source signal characteristics, the selected fixed bit rate mode also depends on the source signal characteristics.

Use of the sets of tuning parameters enables a closed loop type control arrangement wherein the given target average bit rate can be achieved by using different tuning sets obtained from a source of tuning parameters. A number of sets of tuning parameters may be used for the selection of the codec modes based on a bit rate target.

The values of the tuning parameters may be tuned manually to be the most optimal combination of different tuning parameters. The parameters can be selected to define the criteria and calculation thresholds based on which the codec mode can be selected. Each set of tuning parameters may give a different average bit rate. The bit rate target can then be obtained by changing the set of tuning parameters in accordance with a predetermined control rule. In a simple case the control rule can be such that the parameter set for mode selection is changed according to a determined difference between estimated average bit rate and the given bit rate target.

The tuning sets may be set to give different average bit rates. The sets may be set such that some tolerance is allowed in the selection.

At least one frame of the speech signal output from the DTX block 32 may then be encoded by means of an appropriate encoding technique by means of the selected mode at step 106. The desired average bit rate may be produced by changing between different fixed bit rate modes of the codec.

If a new bit rate target is required at step 108, the new bit rate target is input and the encoding mode is selected, as above. If the bit rate target remains the same, encoding of the frames continues at step 110 with the mode selected at step 104.

A possible operation of the adaptation algorithm block 20 is now described in more detail below with reference to FIG. 4. The rate determination algorithm block 20 is shown to comprise sub-blocks for a bit rate target tuning function 21, a tuning codebook 23, a mode selection algorithm 24, a mode set 25 and an average bit rate estimation 26.

The bit rate target 22 input into the tuning function 21 can be set arbitrary to be within a certain bit rate range. The range preferably depends on the bit-rates of the available codec modes such that it covers all available bit rates.

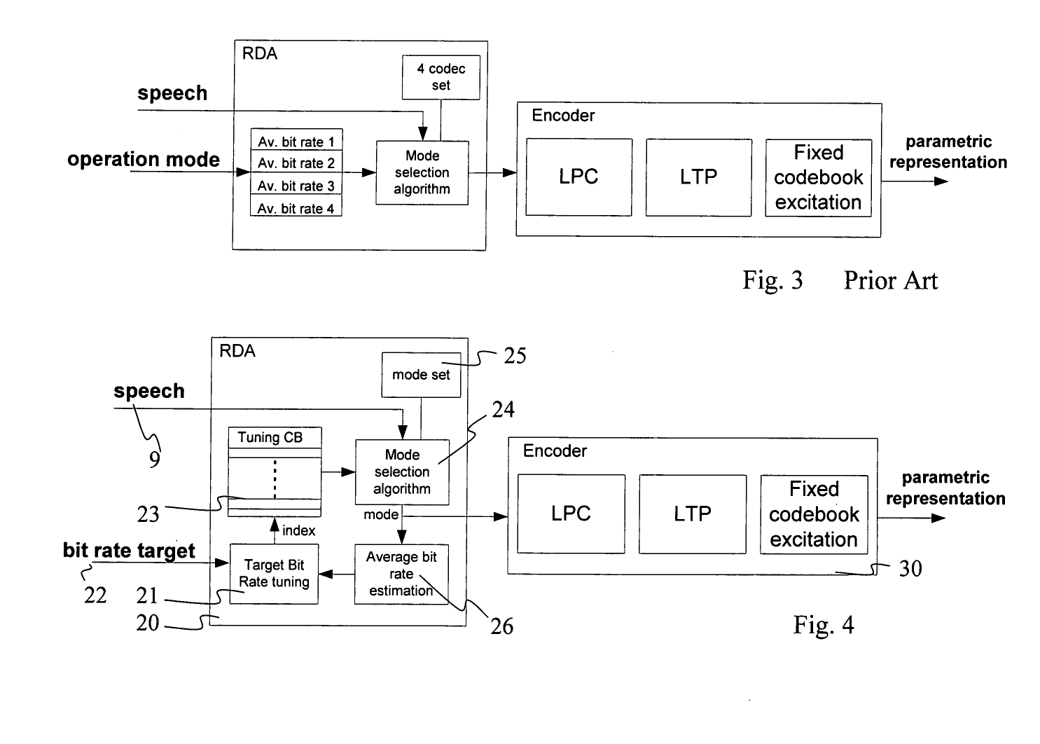

When comparing FIGS. 3 and 4, it can be seen how the principle of this invention is different from the prior art rate determination algorithm (RDA) of the selectable mode vocoder (SMV) described above and shown in FIG. 3 in that the encoding mode is selected based on a bit rate target. In a preferred embodiment the selection algorithm tunes the bit rate based on results from the average bit rate estimation.

Parameters used by the algorithm in selection of the mode are then set based on the bit rate target. For example, the selection thresholds of the mode selection algorithm may be set based on the value of the bit rate target.

The bit rate target 22 does not need to equal with a bit rate of a given mode, as is the case in the prior art. Instead, the bit rate target can be selected to be a desired average bit rate for encoding. The bit rate target may be set and controlled by the network operator.

The embodiment provides a group of different speech codecs by means of the selectable modes. For example, different ANR speech codec modes with different bit rates may be provided.

The rate determination algorithm (RDA) 20 may settle the average bit rate to the bit rate target. This may be done by means of a loop formed by the average bit rate estimation at 26, bit rate target tuning at 21, the tuning codebook (CB) at 23, and mode selection algorithm at 24.

A possible way of implementing the source controlled variable rate codec is to use predetermined sets of tuning parameter values for the average bit-rates for the mode selection. In FIG. 2 the sets of tuning parameters are provided by means of the tuning codebook 23.

The mode set block 25 is for defining the active mode set. The active mode set is the group of speech codec modes which are available for encoding. The modes may be sequenced in growing bit rate order. An example active mode set can be as follows:
M^{set}=[4.75 kbps 5.90 kbps 7.40 kbps 12.2 kbps]
where M₁^{set} is the mode with lowest coding rate.

Operation mode is the highest mode in the active codec set. This mode may be chosen according to channel conditions, for example by means of link adaptation (LA).

All speech codec modes do not need to be supported for the source based bit rate algorithm. Therefore the active mode set may be a subset of all possible speech codec modes.

Average bit rate estimation block 26 is for estimating the average bit rate of the already encoded speech frames. The average bit rate may be based on past history. For example, the average bit rate may be computed for the last 100 frames.

The tuning codebook 23 includes tuning parameters for use in the mode selection algorithm. A tuning codebook may contain a number of manually or otherwise optimised tuning parameters for a number of fixed target bit-rates. The tuning codebook may reduce complexity of the mode selection such that the number of possible options in the set of tuning parameters may be less than what is the number of possible bit rate targets. For example, the tuning codebook may contain parameter values for only a few different average bit-rates. The target bit-rates between those values may then be achieved by alternatively using different tuning codebook indices to reach the targeted average bit-rate.

The bit rate adaptation algorithm compares analysed speech parameters on certain thresholds. The values of the used thresholds depend on the bit rate target set.

For example, the thresholds used in the mode selection may be stored in the tuning codebook (CB) 23. The tuning codebook may be a matrix where each row includes a set of tuned thresholds for certain average bit rate. Therefore, a column may indicate all tuned values for certain thresholds. For example, the element p_{TCB}^{X}^{ᵣ}^{,a} from matrix TCB below could indicate ath tuning parameter for the average bit rates of Xᵣ kbps. An index pointing towards first row may then give parameter set for highest bit rate X₁ and highest index pointing towards last row gives parameter set for lowest bit rate Xₙ.

$$TCB = [ \begin{matrix}{p}_{TCB}^{{X}_{1} , 1} & {p}_{TCB}^{{X}_{1} , 2} & \cdot & ⋯ & {p}_{TCB}^{{X}_{1} , m} \\ {p}_{TCB}^{{X}_{2} , 1} & \cdot & & & \cdot \\ \cdot & & \cdot & & \cdot \\ \cdot & & & \cdot & \cdot \\ {p}_{TCB}^{{X}_{n} , 1} & \cdot & \cdot & ⋯ & {p}_{TCB}^{{X}_{n} , m}\end{matrix} ]$$

This enables tuning that is dependent on the active mode set.

In the arrangement of FIG. 4 the bit rate target may be achieved in closed-loop manner by alternating adaptively between different tuning codebooks to reach a desirable target bit-rate.

An index may be used by the tuning block 21 as a pointer to the tuning parameters of the tuning codebook 23. The index of the tuning codebook may be increased or decreased based on differences between the results of the average bit rate estimation 26 and the bit rate target 22.

The average bit rate can be tuned continuously within a certain bit rate range. The bit rate target is preferably set to be between lowest and highest speech codec modes of active speech codec set. For example, the average bit rate can be tuned continuously within the range from 4.75 to 12.2 Kbit/s. The advantage of this is that network load may be tuned at the maximum capacity offering the maximum speech quality for an arbitrary number of mobile users. Therefore speech quality degradation can be minimised or even eliminated. This may be achieved even if the capacity of the network is increased.

As shown by FIG. 2, the adaptation block 20 may also include additional functions for producing information for the mode selection algorithm. For example, functions such as sub-level normalisation, long term energy calculation, frame content analysis and low threshold tuning may be applied to the speech signal.

The invention may also be applied to messaging applications, where storage space can be filled up optimally with maximum speech quality or with longer message length. The messaging application may comprise applications such as voice messages in MMS (multi media sender) where speech/music or other audio data is recorded, stored and sent.

In messaging type of applications, the storage size can be filled in optimal manner by means of this invention. Therefore, when the available storage size is known, the message can be stored exactly with the same size of data stream. Therefore the highest speech quality can be attained for the message. On the other hand, if needed, longer message can be stored with lower coding resolution by tuning the bit rate target.

The embodiment may be applied to wireless communications both in radio and core networks. Although possible, the radio and core network element do not need to support all possible codec modes. For example, in a radio network, the radio network controller (RNC) 14 may support only a subset of the codec modes.

It is also noted that the above disclosed solution may also be used for scalable rate coding in which the bit rate may be changing from analysis frame to frame based on the source signal.

The above described the source controlled rate adaptation as an extension to the AMR speech codecs. However, similar principles can be applied to any other multi-rate speech codecs.

The embodiment may provide a speech codec where the average bit rate during active speech can be significantly reduced. Higher capacity may be achieved in networks and storage applications while maintaining the same speech quality.

It should be appreciated that whilst embodiments of the present invention have been described in relation to user equipment such as mobile stations, embodiments of the present invention are applicable to any other suitable type of transmission and/or reception nodes. Thus, although the exemplifying embodiments of the invention have discussed the encoding and decoding between a user equipment and a network entity, the present invention can be applicable to any other types of elements associated with a communication system where applicable.

The embodiment of the present invention has been described in the context of a WCDMA systems. This invention is also applicable to any other access techniques including time division multiple access, frequency division multiple access or space division multiple access as well as any hybrids thereof. The used communication system may set some limitation for source based rate adaptation performance. For example, in the GSM the codec mode can be changed only in every 40 ms. This limitation means that in the GSM systems the mode can be changed for every second speech frame only. In certain system it may be that the selected mode can only be one of the neighbour modes in a active codec set.

It is also noted herein that while the above describes exemplifying embodiments of the invention, there are several variations and modifications which may be made to the disclosed solution without departing from the scope of the present invention as defined in the appended claims.

1. A method for multi-rate encoding in a communication system, the method comprising the steps of:
providing a codec with sets of tuning parameters for use in selection of codec modes, wherein a set of said tuning parameters provides an average bit rate;
receiving a bit rate target for encoding a signal by the codec, the bit rate target having a value between a minimum and maximum average bit rate of the codec;
selecting an encoding mode based on the bit rate target and the sets of tuning parameters; and
encoding the signal by a selected encoding mode.

2. A method as claimed in claim 1, further comprising the step of: changing the bit rate target during an active connection.

3. A method as claimed in claim 1, wherein the step of selecting comprises selecting a set of tuning parameters based on estimated average bit rate and the bit rate target.

4. A method as claimed in claim 1, wherein the step of providing comprises providing a number of sets of tuning parameters less than a number of bit rate targets.

5. A method as claimed in claim 1, wherein the step of providing comprises associating the set of tuning parameters with predefined source signal characteristics.

6. A method as claimed in claim 1, further comprising:
setting of parameters of a mode selection algorithm of the codec based on the bit rate target.

7. A method as claimed in claim 6, wherein the step of setting comprises setting selection thresholds of the mode selection algorithm based on the bit rate target.

8. A method as claimed in claim 1, further comprising: operating the codec such that the average bit rate of the codec is settled to the bit rate target.

9. A method as claimed in claim 8, further comprising: producing the average bit rate by changing between at least two different fixed bit rate modes in accordance with at least one set of tuning parameters.

10. A method as claimed in claim 1, wherein the step of selecting comprises selecting the encoding mode by a loop formed by an average bit rate estimation function, a bit rate target tuning function, a source of tuning parameters, and a mode selection algorithm.

11. A method as claimed in claim 1, wherein the step of selecting the encoding mode comprises changing adaptively between different sets of tuning parameters defined for different bit rate targets.

12. A method as claimed in claim 1, further comprising: increasing or decreasing an index value of a tuning codebook based on determined differences between results of average bit rate estimation and the bit rate target.

13. A method as claimed in claim 1, further comprising:
tuning of an average bit rate of the codec continuously by means of a bit rate target within a predefined bit rate range.

14. A method as claimed in claim 1, wherein the step of selecting the encoding mode comprises using, in addition to the bit rate target, further information.

15. A method as claimed in claim 14, wherein the step of selecting comprises using information from at least one of a sub-level normalization, a long term energy calculation, a frame content analysis, and a low threshold tuning.

16. A method as claimed in claim 1, wherein the step of receiving comprises receiving the bit rate target for encoding the signal comprising an audio signal.

17. A multi-rate codec comprising:
an encoder for encoding signals;
a source for provision of sets of tuning parameters, a set of tuning parameters providing an average bit rate;
an input for a bit rate target, the bit rate target having a value between the minimum and maximum average bit rate of a codec; and
a selector for selecting an encoding mode from a set of encoding modes based on the bit rate target and the sets of tuning parameters, the codec being configured to encode signals by an encoding mode selected by the selector.

18. A multi-rate codec as claimed in claim 17, the wherein the codec is configured to receive a new bit rate target during an active transmission and to encode a signal of the active transmission based on different encoding modes in accordance with selections by the selector.

19. A multi-rate codec as claimed in claim 17, wherein the source comprises a storage integrated with the codec for storing the sets of tuning parameters.

20. A multi-rate codec as claimed in claim 17, wherein the codec comprises an average bit rate estimator, and wherein the selector is configured to select tuning parameters based on an estimated average bit rate, the set of tuning parameters and the bit rate target.

21. A multi-rate codec as claimed in claim 17, wherein the codec comprises a looped array formed by an average bit rate estimator, a bit rate target tuning function, a source of tuning parameters, and a mode selection algorithm.

22. A multi-rate codec as claimed in claim 17, wherein the selector is configured to change adaptively between different sets of tuning parameters defined for different bit rate targets.

23. A multi-rate codec as claimed in claim 17, wherein the codec is configured to produce an average bit rate by changing between at least two different fixed bit rate modes in accordance with a set of tuning parameters.

24. A communication system comprising a transmitting node provided with an encoder for encoding signals and a receiving node provided with a decoder for decoding signals from the transmitting node, the system comprising:
a storage for storing sets of tuning parameters, a set of tuning parameters providing an average bit rate;
an input for a bit rate target, the bit rate target having a value between a minimum and maximum average bit rate of the codec; and
a selector for selecting an encoding mode from a set of encoding modes based on the bit rate target and the sets of tuning parameters, the codec being configured to encode signals by an encoding mode selected by the selector.
